(19) United States
(12) Patent Application Publication
(10) Pub. No.: US 2014/0022755 A1
(43) Pub. Date: Jan. 23, 2014

(54) RACK AND CABLE MANAGEMENT DEVICE

(71) Applicant: FUJITSU LIMITED, Kawasaki-shi (JP)

(72) Inventor: Takashi SAITO, Kawasaki (JP)

(73) Assignee: FUJITSU LIMITED, Kawasaki-shi (JP)

(21) Appl. No.: 14/033,824

(22) Filed: Sep. 23, 2013

Related U.S. Application Data
(63) Continuation of application No. PCT/JP2011/057199, filed on Mar. 24, 2011.

(51) Int. Cl. H02G 11/00

(52) U.S. Cl. CPC H02G 11/00
USPC 361/829; 174/135

(57) ABSTRACT

A rack includes a rack body part in which electronic devices are housed vertically; and cable holding bars each of which is fixed to one of fixing members each pivotably supported by a rotary shaft provided on the rack body part so as to be vertically rotatable, each of the cable holding bars being extended in an axis direction of the rotary shaft; wherein each of the fixing members has such a shape that distances between the cable holding bars and the rotary shaft mutually differ, and, when a cable holding bar is rotated upward, each fixing member to which the cable holding bar is fixed whose distance from the rotary shaft is larger than that of the lifted cable holding bar is rotated upward.

### CROSS-REFERENCE TO RELATED APPLICATION

This application is a continuation application of International Application PCT/JP2011/057199 filed on Mar. 24, 2011 and designated the U.S., the entire contents of which are incorporated herein by reference.

### FIELD

The present invention relates to a rack for housing electronic devices and a cable management device capable of being housed within a rack.

### BACKGROUND

In a data center (an Internet data center etc.), a plurality of electronic devices (computer device, communication device, etc.) are housed in each of a plurality of racks. Previously, cables related to the electronic devices in the racks were stored in the underfloor, however, it has become popular to store the cables separately in the underfloor and on the ceiling side.

Specifically, since sophistication (miniaturization of one device per function) has progressed, the electric device in recent years has more connectors, to each of which a cable has to be connected, larger than the conventional electronic device. Therefore, as schematically illustrated in FIG. 1, amount of the cables connected to each rack (to the electronic devices in each rack) has been increasing to the amount that occupies the greater part of the underfloor that functions also as a supply path of cooling air from an air-conditioning machine to each rack if the cables are stored in the underfloor.

On the other hand, as schematically illustrated in FIGS. 2A and 2B, if the cables from each rack are stored separately in the underfloor and on the ceiling side by attaching a cable rack to the ceiling of a server room etc., it is possible to reserve a space for supplying the cooling air from the air-conditioning machine. It is furthermore possible to lessen the number of the cables existing in the lower part of each rack (to arrange the cables to each rack orderly). Therefore, it has become popular to store the cables from each rack separately in the underfloor and on the ceiling side.

Note that, although a state where each cable is simply connected to each electronic device in the rack is depicted in each of FIGS. 1, 2A and 2B, in the case of simply connecting the cables to the electric device, the cables get entangled easily, and the cables may become obstacles when a maintenance work for the electronic devices is performed. Therefore, a device, which is called a cable management arm, having the structure depicted in FIGS. 3A and 3B is commercially available. That is, a device is commercially available which has a shape like an arm having a plurality of joints, is fixed to the electronic device and the rack, and can prevent, by fastening cables to it with hook-and-loop fasteners etc., the cables from getting entangled when the electric device is inserted into or removed from the rack.

Further, there exist a device that corresponds to a upright version of this cable management arm.

### PRIOR ART REFERENCE

Patent Document 1: Japanese Examined Patent Application Publication No. 07-95862

Patent Document 2: Japanese Patent Laid-Open Publication No. 2006-136182

Patent Document 3: Japanese Patent Laid-Open Publication No. 2008-146321

As mentioned above, the cables related to each rack are stored separately in the underfloor and on the ceiling side, however, when the cables are stored also on the ceiling side, the maintenance work of some electronic devices in the rack will become difficult.

Specifically, when a maintenance work for an electronic device in a rack in a data center etc. is performed, it is sometimes necessary to remove cables from the electronic device to be maintained (which will be denoted hereinafter as the maintenance object device). In such a case, if every cable from the rack is stored in the underfloor of the data center etc., it is only required to remove the cables from the maintenance object device and the electric devices positioned above it. The reason is that, if every cable from the rack is stored in the underfloor, as schematically illustrated in FIGS. 4A and 4B., it is possible to form a state where the cables disturbing the work do not exist on the rear side of the maintenance object device just by placing the cables removed from the maintenance object device etc., on the floor.

Let's now consider the case where a maintenance work is performed for an electronic device to which cables from the ceiling side are connected in the data center etc. in which cables are also stored on the ceiling side. In this case, as depicted in FIGS. 5A and 5B, the cables connected to the electronic device (the highest electronic device in FIGS. 5A and 5B; denoted hereinafter as the work object device) are removed, and therefore the removed cables hang down from the ceiling side by their own weight. Moreover, the cables removed from the second through sixth electric devices so that work can be done without hindrance by them also hang down from the ceiling side by their own weight.

Consequently, it follows that the maintenance work for the work object device has to be performed while pushing the cables aside which hang down from the ceiling side by their own weight or after bundling the cables and then moving the bundled cables aside. However, it is difficult to work while pushing the cables aside. Further, the work of bundling cables is a complicated work, and there may be no part to which the bundled cable can be fixed.

### SUMMARY

According to an aspect of the embodiments, a rack includes: a rack body part in which electronic devices are housed vertically; and cable holding bars each of which is fixed to one of fixing members each pivotably supported by a rotary shaft provided on the rack body part so as to be vertically rotatable, each of the cable holding bars being extended in an axis direction of the rotary shaft; wherein each of the fixing members has such a shape that distances between the cable holding bars and the rotary shaft mutually differ, and, when a cable holding bar is rotated upward, each fixing member to which the cable holding bar is fixed whose distance from the rotary shaft is larger than that of the lifted cable holding bar is rotated upward.

According to another aspect of the embodiments, a cable management device for a rack in which electronic devices are housed vertically includes: a housing having a shape capable of being placed in the rack; and a cable management assembly attached to the housing so as to be housed in the housing and to be taken out from the housing; wherein the cable management assembly includes fixing members that are rotatable on a rotary shaft provided on the housing, cable holding bars each of which is fixed to one of fixing members and is extended in an axis direction of the rotary shaft, wherein the fixing members cable holding bars have such shape and position relationship that distances between the cable holding bars and the rotary shaft mutually differ and, when a cable holding bar is lifted, each fixing member to which the cable holding bar is fixed whose distance from the rotary shaft is larger than that of the lifted cable holding bar to rotate upward.

The object and advantages of the invention will be realized and attained by means of the elements and combinations particularly pointed out in the claims.

It is to be understood that both the foregoing general description and the following detailed description are exemplary and explanatory and are not restrictive of the invention.

### BRIEF DESCRIPTION OF DRAWINGS

FIG. 1 is a diagram schematically illustrating a condition where cables related to electronic devices in a rack are stored in the underfloor;

FIG. 2A is a diagram schematically illustrating a condition where cables related to electronic devices in a rack are stored separately in the underfloor and on the ceiling side;

FIG. 2B is a diagram schematically illustrating a condition where cables related to electronic device in a rack are stored separately in the underfloor and on the ceiling side;

FIG. 3A is an explanatory diagram of a cable management arm;

FIG. 3B is an explanatory diagram of the cable management arm;

FIG. 4A is a diagram schematically illustrating a condition at the time of maintenance work of the electronic devices in the rack in a case where the cables related to the electronic devices are stored in the underfloor;

FIG. 4B is a diagram schematically illustrating a condition at the time of maintenance work of the electronic devices in the rack in a case where the cables related to the electronic devices are stored in the underfloor;

FIG. 5A is a diagram schematically illustrating a condition at the time of maintenance work of the electronic devices related to the cables from the ceiling side;

FIG. 5B is a diagram schematically illustrating a condition at the time of maintenance work of the electronic devices related to the cables from the ceiling side;

FIG. 6 is a rear view of a rack (where housing of the electronic devices and connection of the cables are completed) according to a first embodiment of the present invention.

FIG. 7 is a side view of the rack according to the first embodiment;

FIG. 8 is a partial exploded perspective view of the cable management assembly according to the first embodiment (the cable management assembly included in the rack according to the first embodiment);

FIG. 9 is a partial exploded perspective view of the cable management assembly according to the first embodiment;

FIG. 10 is a partial projective diagram of the cable management assembly according to the first embodiment, which is in a state where support arms are overlapped each other, from the front end side of the support arms;

FIG. 11 is an explanatory diagram of the cable management assembly according to the first embodiment;

FIG. 12 is an explanatory diagram of an example of use of the cable management assembly according to the first embodiment;

FIG. 13 is an explanatory diagram of another example of use of the cable management assembly according to the first embodiment;

FIG. 14 is a rear view of the rack (where housing of the electronic devices and connection of the cables are completed) according to the first embodiment of the present invention.

FIG. 15 is a partial exploded perspective view of the cable management assembly according to the second embodiment (the cable management assembly included in the rack according to the second embodiment);

FIG. 16 is a partial perspective view of the cable management assembly according to the second embodiment;

FIG. 17A is explanatory diagram of the function and shape of the arm holding member of the cable management assembly according to the second embodiment;

FIG. 17B is explanatory diagram of the function and shape of the arm holding member of the cable management assembly according to the second embodiment;

FIG. 17C is explanatory diagram of the function and shape of the arm holding member of the cable management assembly according to the second embodiment;

FIG. 18 is a partial exploded perspective view of a rack according to the third embodiment of the present invention;

FIG. 19 is an explanatory diagram of a phenomenon (slipping out of a cable) which may occur at the rack according to the first embodiment when the cables hooked on the lifted cable holding bar slide;

FIG. 20 is a diagram illustrating a condition of the rack (the cable management assembly) according to the third embodiment when the cables hooked on the lifted cable holding bar slide;

FIG. 21 is an outline view of the cable management device according to the fourth embodiment of the present invention;

FIG. 22 is an explanatory diagram of a use form of the cable management device according to the fourth embodiment;

FIG. 23 is a partial exploded perspective view of the cable management device according to the fourth embodiment.

FIG. 24 is a partial view from the cable holding bar side about the cable management device which requires each support cable for the fourth embodiment accommodated in package circles.

FIG. 25A is a sectional view of the cable management device according to the fourth embodiment, which is viewed from the arrow direction of the A-A line in FIG. 24; and

FIG. 25B is a sectional view of the cable management device according to the fourth embodiment, which is viewed from the arrow direction of the A-A line in FIG. 24.

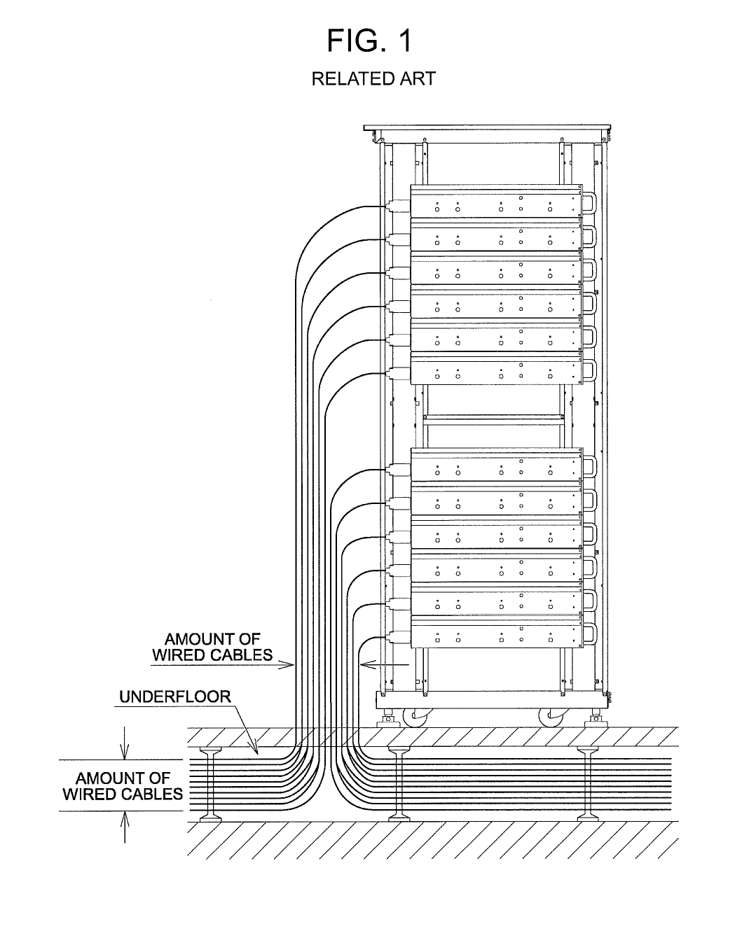

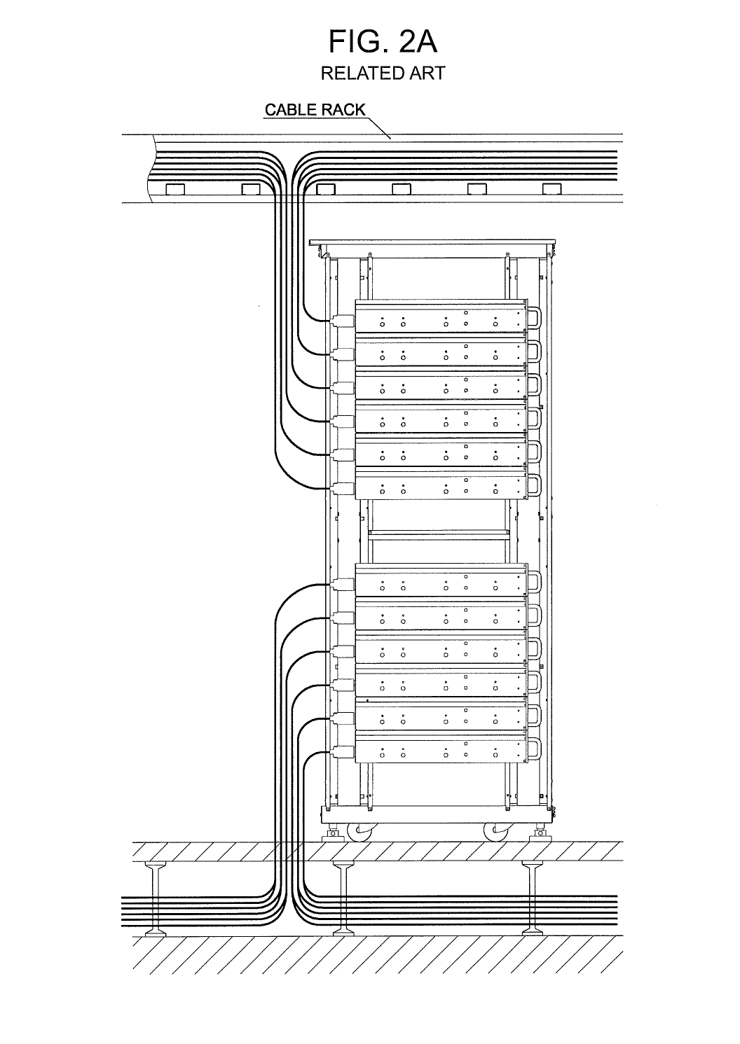

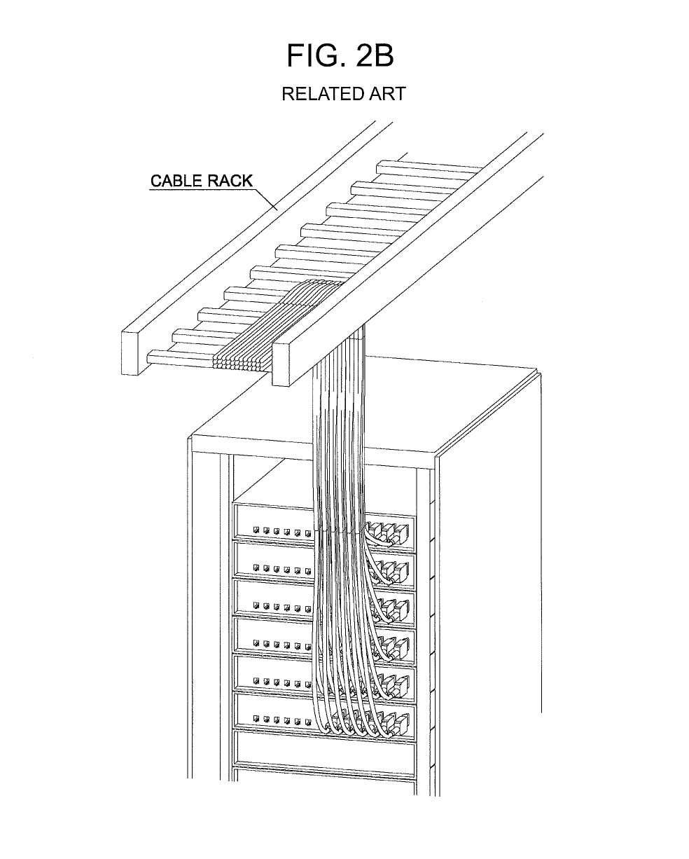

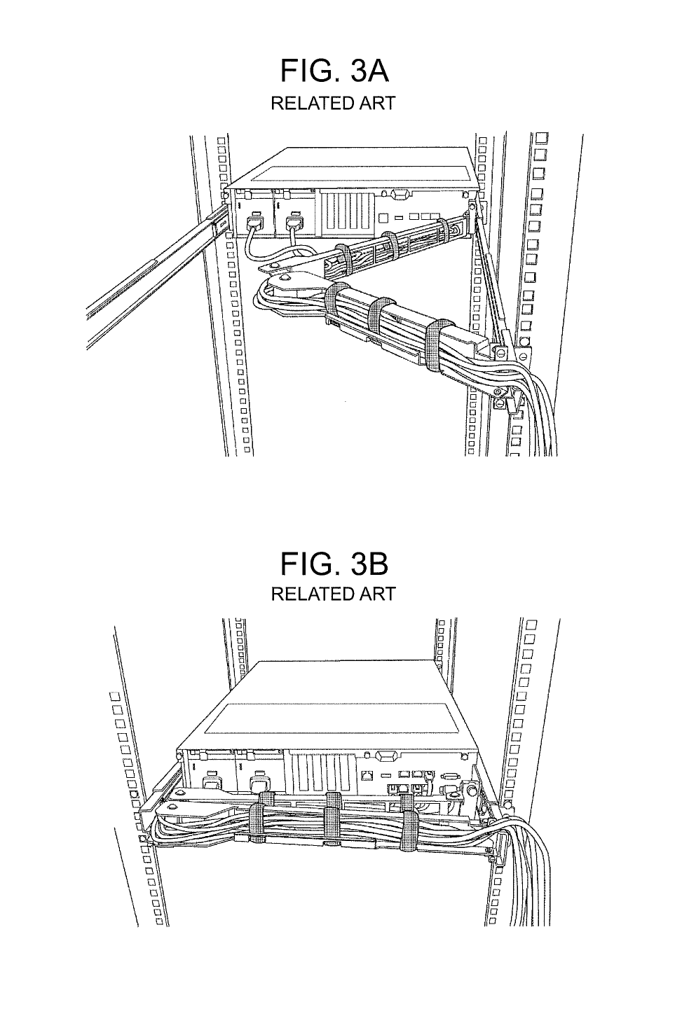

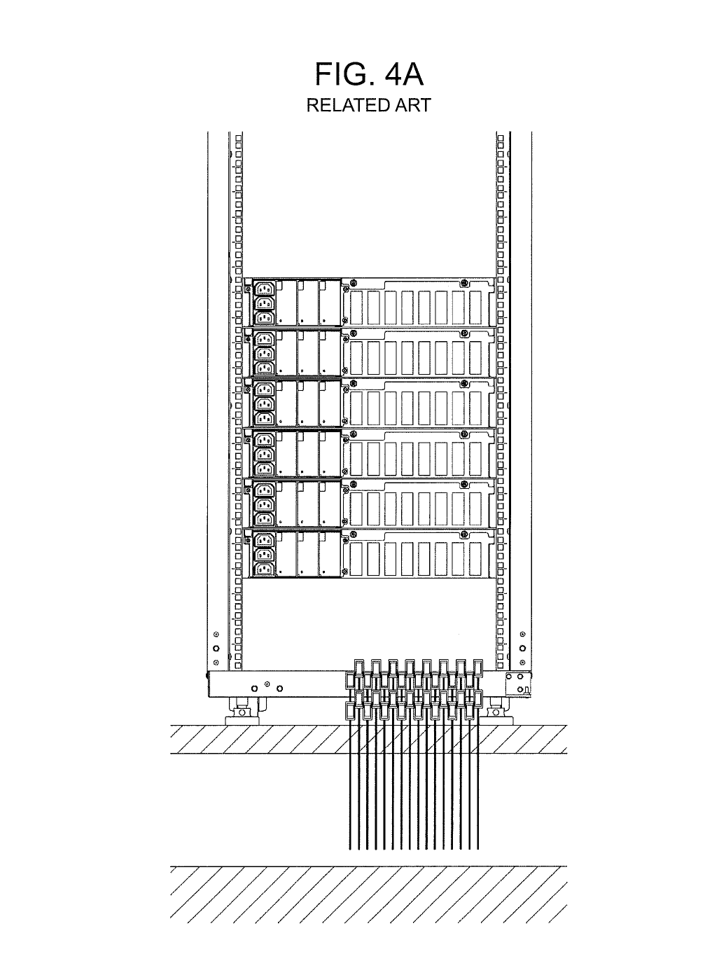

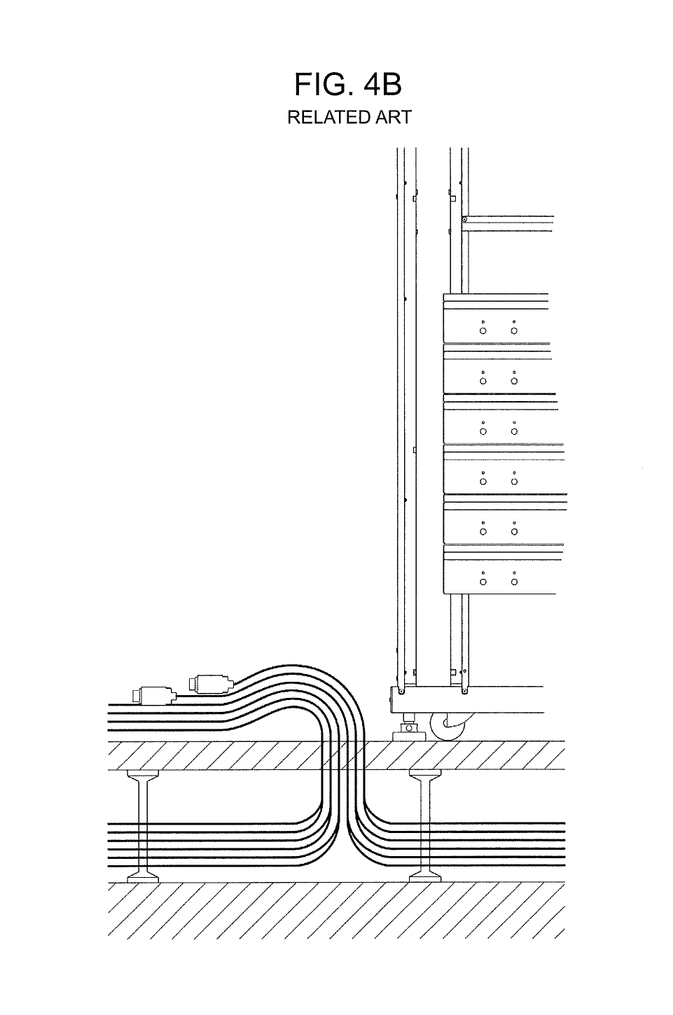

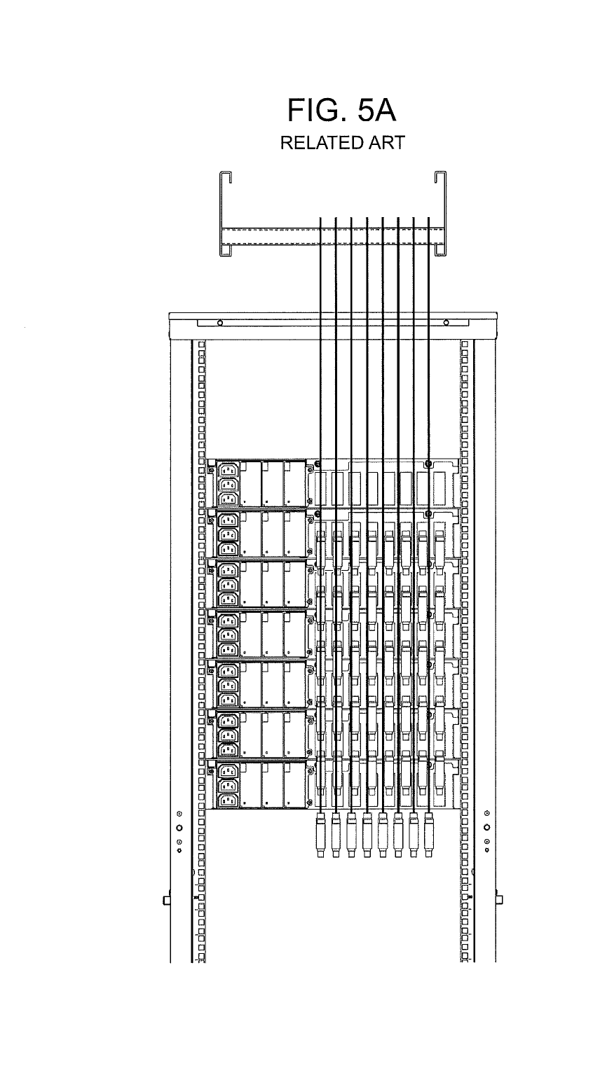

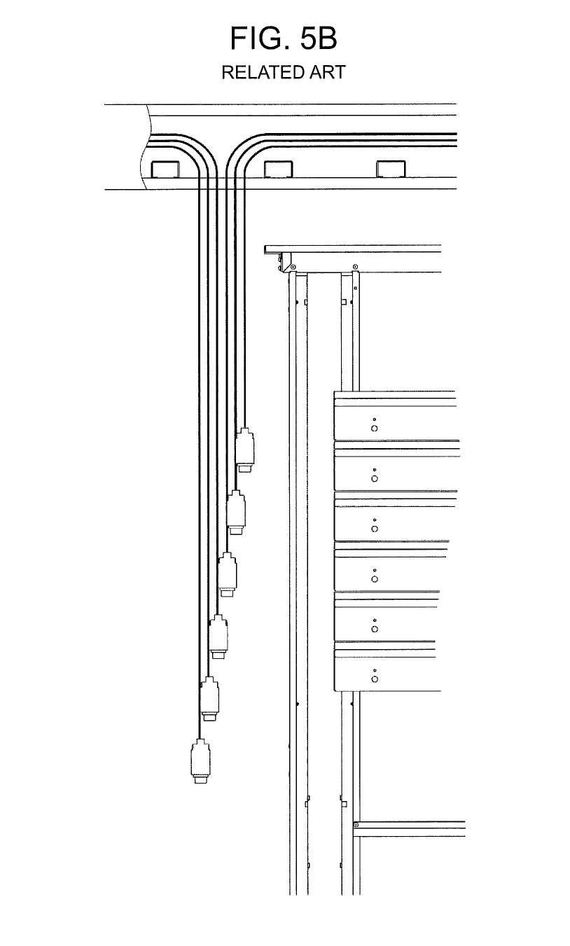

### DESCRIPTION OF EMBODIMENTS

An in-depth description of some embodiments of the present invention will hereinafter be given with reference to the drawings. Note that, each embodiment described below is an example of the present invention, and the present invention is not limited to the configuration of each embodiment.

### First Embodiment

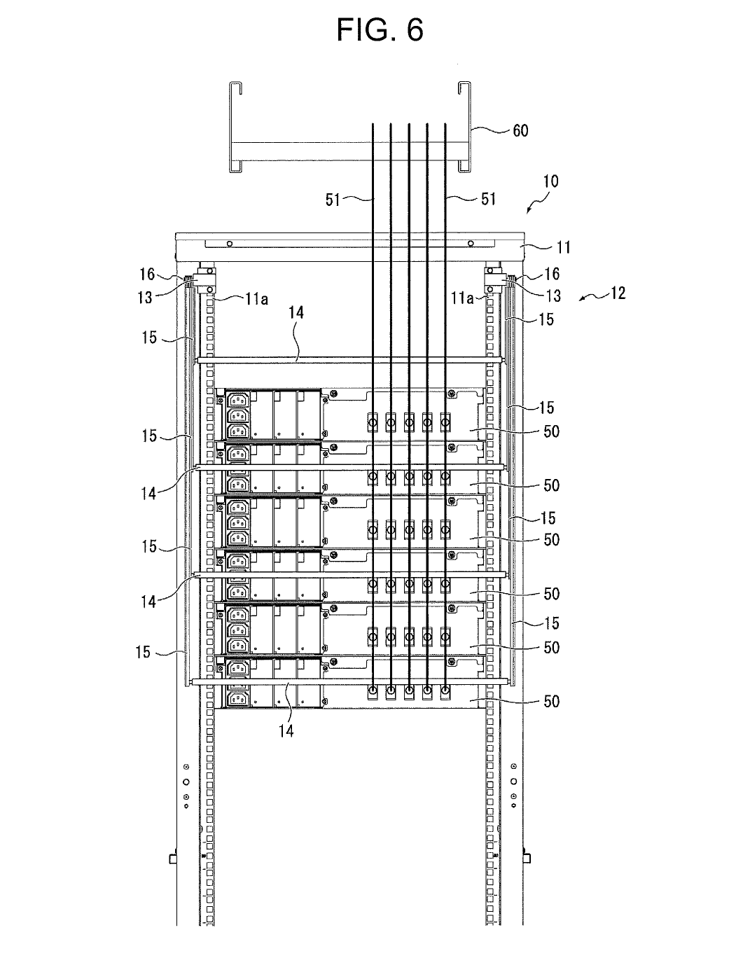

To start with, structure of a rack according to a first embodiment of the present invention will be described referring to FIGS. 6 to 10.

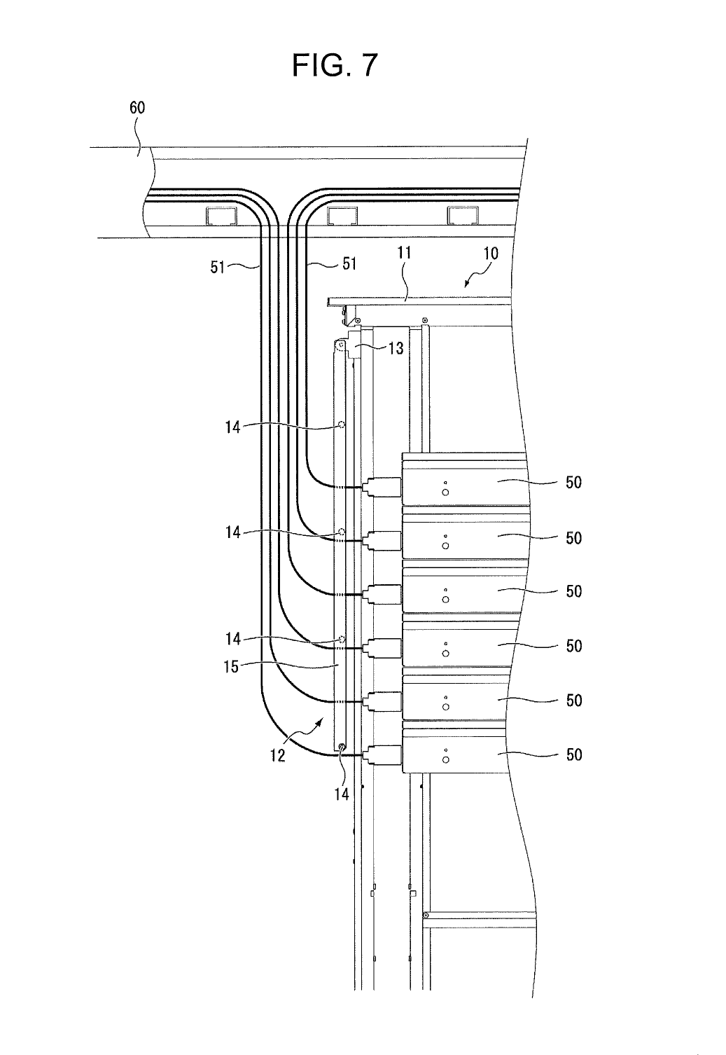

In these drawings, FIGS. 6 and 7 are respectively rear and side views of the rack 10 where housing of the electronic devices 50 and connection of cables 51 from a cable rack 60 side to the electronic devices 50 have been completed. Incidentally, the rear (rear face) of the rack is, same as its common meaning, the face of the rack to which the cables are attached (the face from which the rear face of each electronic device 50 in the rack can be viewed).

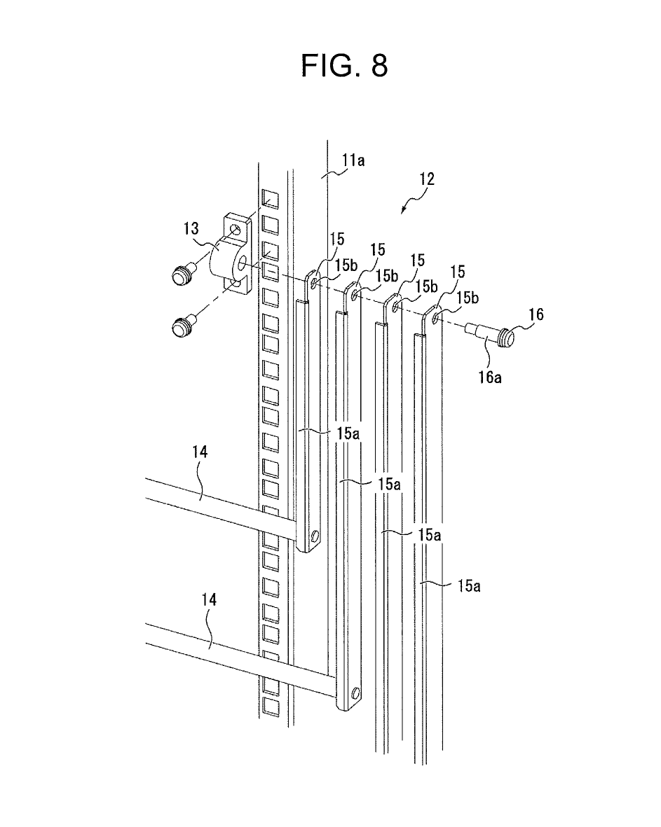

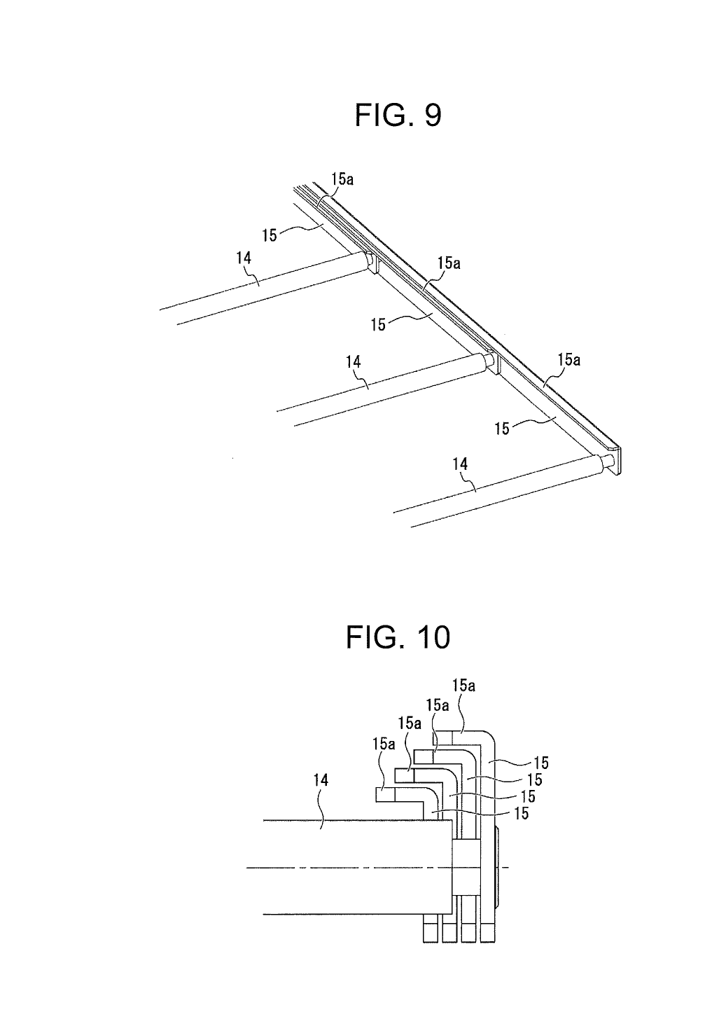

FIG. 8 is a partial exploded perspective view of a cable management assembly 12 (described in detail later), and FIG. 9 is a partial perspective view of the cable management assembly 12. Further, FIG. 10 is a partial projective diagram of the cable management assembly 12, which is in a state where support arms 15 (described in detail later) are overlapped, from the front end side of the support arms 15.

As illustrated in FIGS. 6 and 7, the rack 10 according to the present embodiment is used in the form where the cables 51 related to several electronic devices 50 are stored in the cable rack 60 fixed to the ceiling. The rack 10 includes a rack body part 11 and the cable management assembly 12.

The rack body part 11 is a cabinet in which a plurality of rack-mounted type electronic devices 50 can be placed. The rack body part 11 has the same structure as a common rack (a server rack, a network rack, etc.).

The cable management assembly 12 (which will hereinafter also be termed the CMA 12) is a unit including, as its main components, one pair of (two number of) fixing blocks 13, N number (N≧2; N=4 in this embodiment) of cable holding bars 14, and N pairs of support arms 15.

Each cable holding bar 14 is a rod-like member having a length slightly shorter than the width of the rack body part 11. Hereinafter, the n-th cable holding bar 14 from the top in FIG. 6 will be referred simply to as the n-th cable holding bar 14.

Each pair of support arms 15 (each two support arms 15 paired with each other) is a pair of members which have a mirror image relationship and have front end parts (end parts on the under side in FIG. 6) to which the cable holding bar 14 is rotatably fixed. Although the detailed description of the support arms 15 will be given later on, as depicted in FIG. 8, a penetration hole 15b having a size allowing a shaft part 16a of a rotary shaft member 16 to be passed therethrough is formed in the terminal end part (the end part opposite to the front end part) of each support arm 15.

Each fixing block 13 is a member for fixing the rotary shaft member 16 to the rack body part 11 with an attitude that the axial direction (center direction) of the shaft part 16a becomes horizontal. Each fixing block 13 has a shape capable of being attached to the rack pillar 11a on the rear side of the rack body part 11. Then, the CMA 12 is an assembly that is configured by fixing the fixing block 13 to each rack pillar 11a so as to have the same height and attaching the N number of support arms 15 to the fixing blocks 13 fixed to the rack pillars 11a using the rotary shaft member 16.

The structure (shape) of the support arm 15 will be described more specifically. As illustrated in FIGS. 8 through 10, each support arm 15 of the CMA 12 has a strip-like part to which the cable holding part 14 will be attached and a flange part 15a that is extended from one edge of the strip-like part to the direction of its paired support arm 15.

The shapes (sizes) of the N number of support arms 15 are determined so that positional relationship among the support arms 15 becomes the one illustrated in FIGS. 9 and 10 when they are fixed to the fixing blocks 13 using the rotary shaft member 16. That is, the shapes of the N number of support arms 15 are determined so that the flange part 15a of each support arm 15 touches the flange part 15a of its adjacent support arm 15 when they are placed on a plane surface in order of their length with their flange parts 15a facing upward. Further, the lengths of the support arms 15 are determined so that the support arm 15 becomes longer as its position becomes more outside (so that the support arm 15 for the more lower cable holding bar 14 becomes longer).

Note that the length of each support arm 15 is determined so that each cable holding bar 14 is positioned at a height that causes every connector on the rear faces of the electronic devices 50 not to be covered by any cable holding bar 14 (a height that allows a worker to connect the cable 51 to every connector on the rear faces of the electronic devices 50 without being obstructed by the cable holding bars 14). Consequently, the length of each support arm 15 is determined so that the height of each cable holding bar 14 matches a position of a boundary of specific two electronic devices 50 in the rack body part 11 which are vertically placed in the rack body part 11 or so that the height of each cable holding bar 14 becomes slightly lower than the position (see FIG. 7).

Further, the length of the longest support arm 15 (the support arm 15 for the N-th cable holding bar 14) is determined so that the cables 51 toward the cable rack 60 can pass through under the lowest (N-th) cable holding bar 14. In other words, the length of the longest support arm is determined so that there exists at least one electronic device 50 below the lowest cable holding bar 14 to which the cables 51 from the cable rack 60 side are connected.

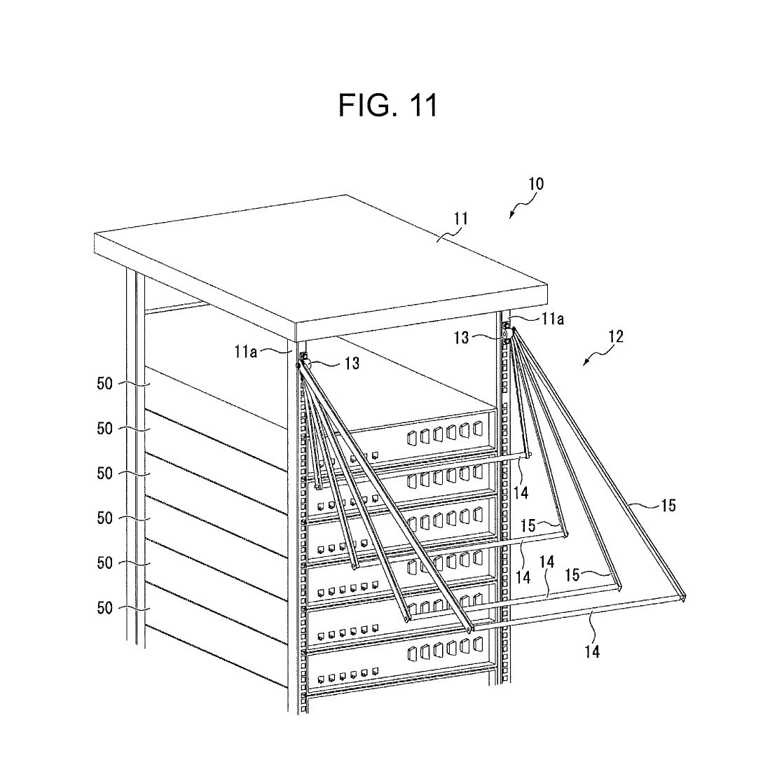

As obvious from the structure described above, the CMA 12 included in the rack 10 according to the present embodiment is, as illustrated in FIG. 11, basically a unit where each cable holding bar 14 can rotate (swing) around the common rotary shaft. However, the CMA 12 has such constitution (see FIG. 10) that, when the n-th (n<N) cable holding bar 14 is lifted, the flange part 15a of the n-th support arm 15 directly or indirectly pushes up the flange part 15a of each of the “n+1”-th through the N-th support arms 15. Incidentally, the n-th support arm 15 is the support arm 15 having the front end part to which the n-th cable holding bar 14 is attached.

Accordingly, when the n-th cable holding bar 14 of the CMA 12 is lifted, each of the “n+1”-th through the N-th support arms 15 is also lifted. Consequently, with the rack 10 according to the present embodiment, it is possible to readily form a state where the cables 51 does not exist at the rear of the electronic device(s) 50 to be maintained.

Specifically, when performing maintenance work for the lowest electronic device 50 in FIG. 7, a worker can form a state where the cable 51 does not exist on the rear side of the lowest electronic device 50 by the following procedure.

1. Remove each cable 51 from the lowest electronic device 50.

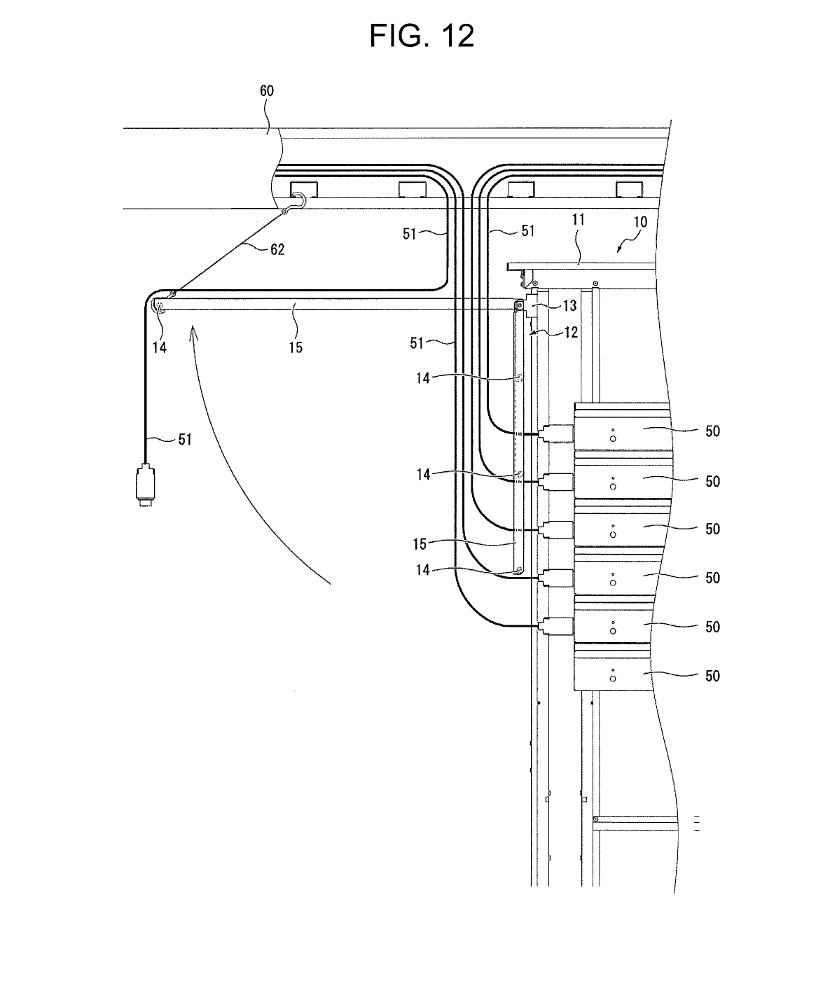

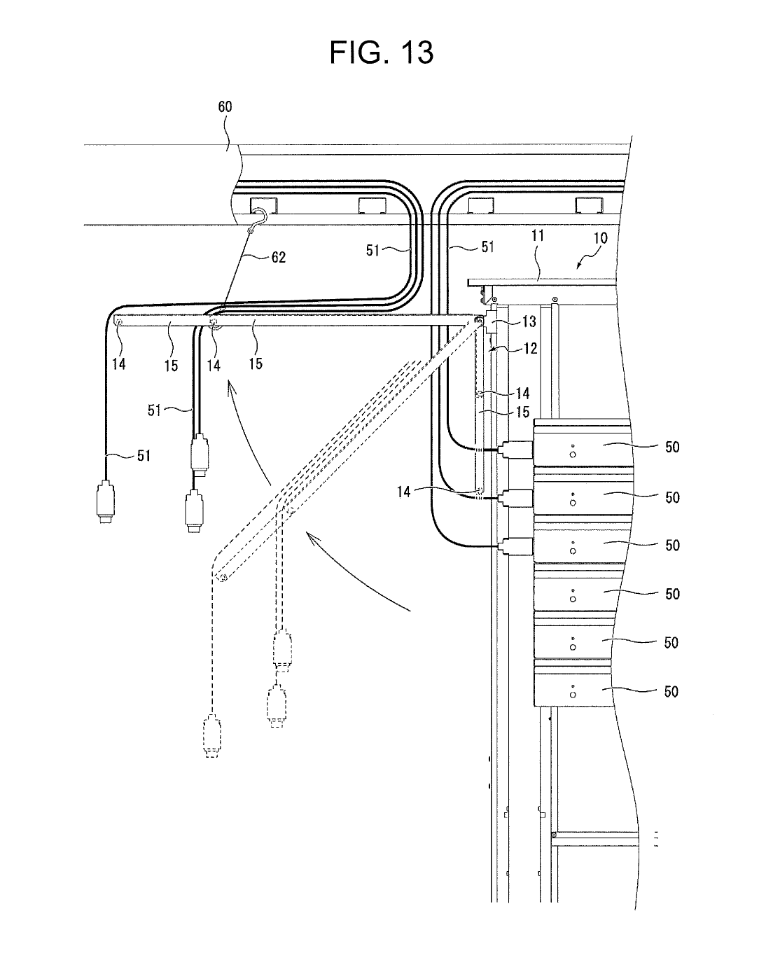

2. Lift the fourth cable holding bar 14 as schematically illustrated in FIG. 12, and fix the lifted cable holding bar 14 to the cable rack 60 using a wire 62 with hooks (a wire having a hook at each end) depicted in the figure or the like.

Further, when performing maintenance work for the fourth electronic device 50 in FIG. 7, the worker can form a state where the cable 51 does not exist on the rear side of the forth electronic device 50 by the following procedure.

1. Remove each cable 51 from the fourth electronic device 50 and each electronic device 50 which is placed below the fourth electronic device 50 and to which cables 51 from the cable rack 60 are connected.

2. As schematically illustrated in FIG. 12, lift the third cable holding bar 14 that is positioned immediately above the connectors of the fourth electronic device 50, and fix the lifted cable holding bar 14 to the cable rack 60 using a wire 62 with hooks or the like.

Thus, the rack 10 according to the present embodiment has such constitution that a state where the cable 51 does not exist on the rear face of the electronic device 50 to be maintained can be formed without performing a work of bundling the cables 51 removed from several electric devices 50. Consequently, with the rack 10, it is feasible to achieve an environment where the maintenance work for the electric device(s) connected with the cables from the ceiling side can be performed more easily.

### Second Embodiment

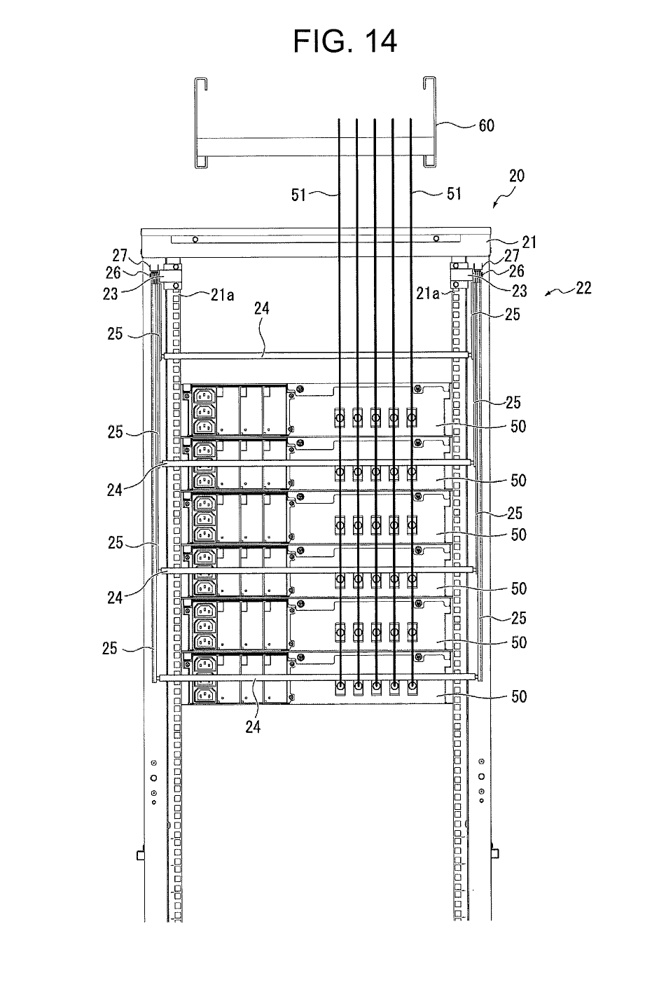

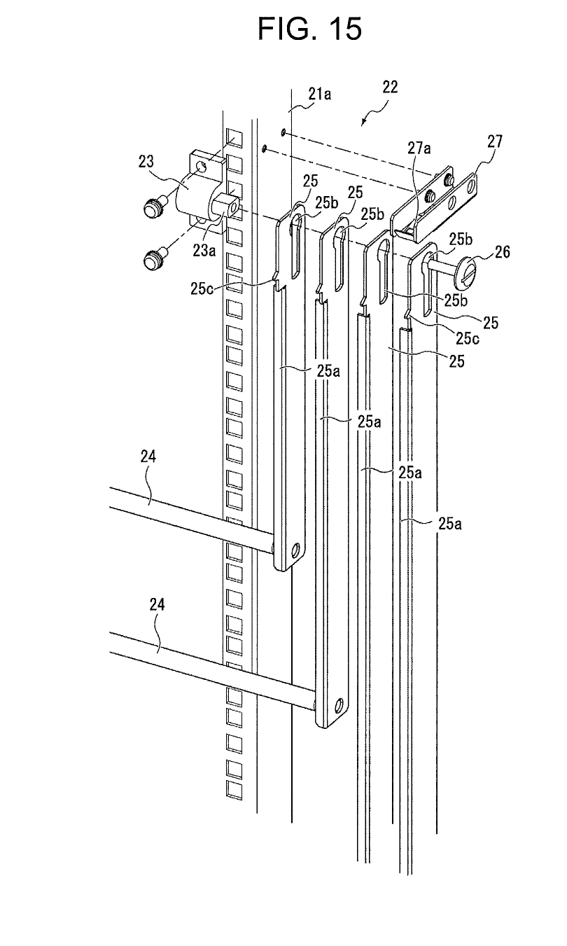

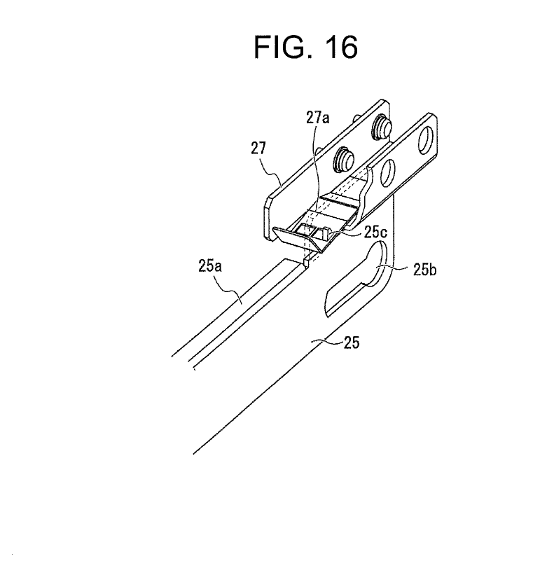

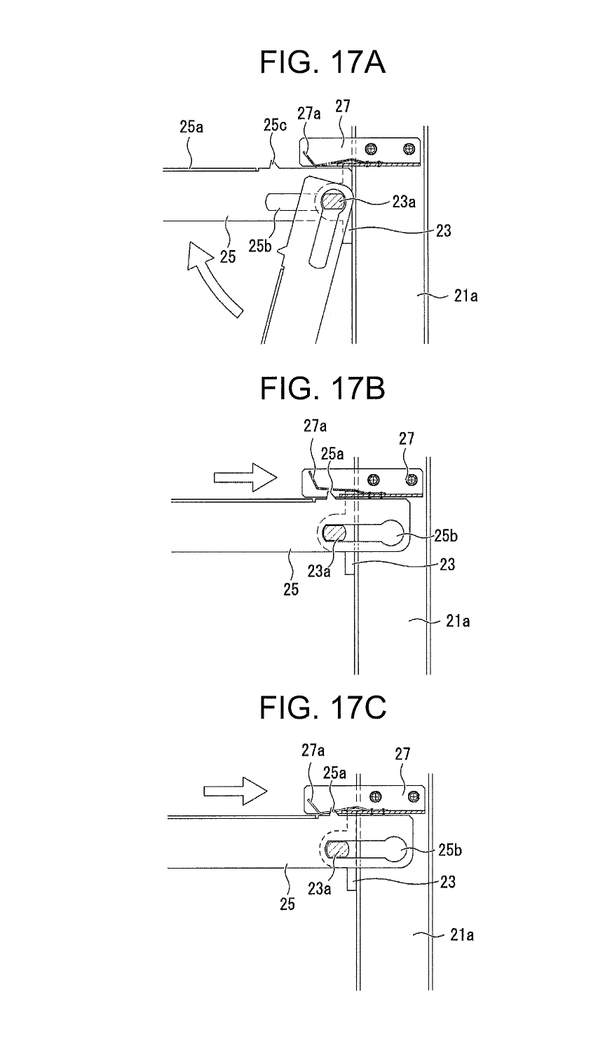

FIGS. 14 through 17 illustrate structure of a rack 20 according to a second embodiment. Note that FIG. is a rear view of the rack 20 where housing of the electronic devices 50 and connection of the cables 51 from the cable rack 60 side are completed. FIG. 15 is a partial exploded perspective view of the CMA (cable management assembly) 22 included in the rack 20. FIG. 16 is a partial perspective view of the CMA 22, and FIGS. 17A through 17C are explanatory diagrams of function and shape of an arm holding member 27.

As illustrated in FIG. 14, the rack 20 according to the present embodiment is a unit used in a condition where the cables 51 related to several electronic devices 50 are stored in the cable rack 60 attached to the ceiling.

The rack 20 includes a rack body part 21 which is the same as the above-mentioned rack body part 11. Moreover, the rack 20 is provided with the CMA 22 that includes, as its main components, one pair of fixing blocks 23, N number (N≧2; N=4 in this embodiment) of cable holding bars 24, N pairs of support arms 15, and one pair of arm holding members 27 (see FIG. 15).

Each cable holding bar 24 that is a component of the CMA 22 is, as with the cable holding bar 14, a rod-like member having a length slightly shorter than the width of the rack body part 21.

Each fixing block 23 is a member that will be attached to the rack pillar 21a on the rear side of the rack body part 21. Each fixing block 23 includes a shaft part 23a that functions as a rotary shaft for the support arms 25 (and the cable holding bars 24). The shaft part 23a of each fixing block 23 has, as depicted in FIG. 15, two flat faces in its side surface which become almost horizontal when the fixing block 23 is fixed to the rack pillar 21a.

Each support arm 25 is, as with the support arm 15, a member that includes a flange part 25a and has the front end part to which the cable holding bar 24 is rotatably attached. However, as illustrated in FIG. 15, the terminal end part of each support arm 25 has a shape different from that of the support arm 15.

Specifically, in the terminal end part of each support arm 25, a keyhole-shaped penetration hole 25b is formed which consists of a circular part which has a size allowing the shaft part 23a of the fixing block 23 to rotate therein and a linear part which is slightly wider than the distance between the flat faces of the shaft part 23a. Moreover, in the terminal end part of each support arm 25, a projection part 25c is formed which has a shape like a trapezoid whose front edge is inclined greatly and which is projected toward the flange part 25a.

Further, the support arms 25 are members that are combined with the shaft part 23a of the fixing block 23 so that the shaft part 23a passes through their penetration hole 25b in a descending order of their length, and the member 26 is a member that is fixed to the shaft part 23a in order to prevent the support arms 25 from being detached from the shaft part 23a.

In short, the rack 20 (CMA 22) has, as with the rack 10 (CMA 12), such constitution that, when the n-th (n=1 to N) cable holding bar 14 is lifted, each of the “n+1”-th through the N-th support arms 15 is also lifted.

Furthermore, the rack 20 also has constitution that, when the n-th cable holding bar 24 is lifted up so that its support arms 25 become nearly horizontal and then is pushed in the depth direction, the shaft part 23a comes in the liner part of the penetration hole 25b of each n-th support arm 25. Consequently, with the rack 20, just by lifting the n-th cable holding bar 24 so that its support arms 25 become almost horizontal and pushing it in the depth direction, a state where the n-th through N-th cable holding bars 24 does not fall down can be formed.

However, with the configuration that keeps the attitude of each support arm 25 only by the frictional force between the shaft part 23a and the penetration holes 25b, there is a possibility that the cable holding bar 24 will fall when a shoulder etc. of a worker touches the cables 51 hung down from the lifted cable holding bar 24.

The projection part 25c of each support arm 25 and the pair of arm holding members 27 are members that serve as the constitution (mechanism) for suppressing the occurrence of such phenomenon.

Specifically, the two arm holding members 27 in the CMA 22 are members that have a mirror image relationship. The arm holding member 27 that is fixed to the right rack pillar 21a as seen from the rear is a member consisting of a metal part (denoted hereinafter as a frame part) having a shape illustrated in FIGS. 16 and 17A through 17C and a holding spring 27a having a shape illustrated in these figures and having one end fixed to the metal part.

That is, the frame part of each arm holding member 27 has a shape that causes, when the arm holding member 27 is attached to the side face of the rack pillar 21a and the shaft part 23a is in the liner part of the penetration hole 25b, the upper face of the support arm 25 to come in contact with its under face.

Moreover, as illustrated in FIGS. 17A and 17B, the holding spring 27a has a free end (an end not fixed to the frame part) that is raised upward when the leveled support arm 25 is pushed in the depth direction. Furthermore, as illustrated in FIGS. 16 and 17C, the holding spring 27a has a penetration hole which is formed at an area where the projection part 25 is positioned when the support arms 25 is pushed into the deepest part (until the shaft part 23 touches the end of the liner part of the penetration hole 25a) and into which the projection part 25c is fitted. More specifically, at the above-mentioned area of the holding spring 27a, two penetration holes each of which is capable of accommodating two projection parts 25c.

As obvious from the discussion given above, the rack 20 has such constitution that, when a cable holding bar 24 is pushed into the deepest part, the projection parts 25c of the two support arms 25 related to the cable holding bar 24 come in the penetration holes of the holding springs 27a of the arm holding members 27. A comparatively large force is required to pull the support arm 25 whose projection part 25c is in the penetration holes of the holding springs 27a. Note that a degree of the slope of the front edge of the projection part 25c of each support arm 25 and the like are determined so that an excessively large force is not required to pull the support arms 25 out from the rack 20 (so that the support arms 25 is able to be pulled out by one hand).

Consequently, when the rack 20 is used, the maintenance work of each electronic device 50 can be done in a condition where it is practically impossible that the cable holding bar 24 falls during work.

### Third Embodiment

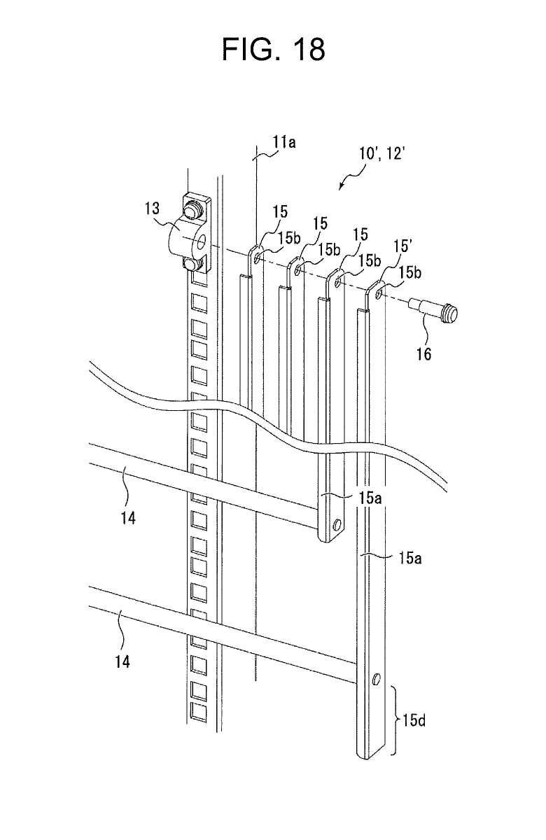

Structure of a rack 10′ according to a third embodiment will be explained referring to FIG. 18 in a way that puts a focus on differences from the rack 10 according to the second embodiment.

As obvious from a comparison between FIG. 18 and FIG. 8, the rack 10′ (CMA 12′) is a unit obtained by substituting each support arm 15 for the lowest cable holding bar 14 in the rack 10 (CMA 12) with a support arm 15′ having a cable guide part 15d.

Here, the cable guide part 15d is a front end part of the support arm 15′ rather than the attaching position of the cable holding bar 14. The cable guide part 15d is formed by extending the support arm 15′ in the front direction. Length of the cable guide part 15d in the vertical direction in FIG. 18 should be equal to or larger than the diameter of the cable 51. The length is, for example, 2 to 3 cm.

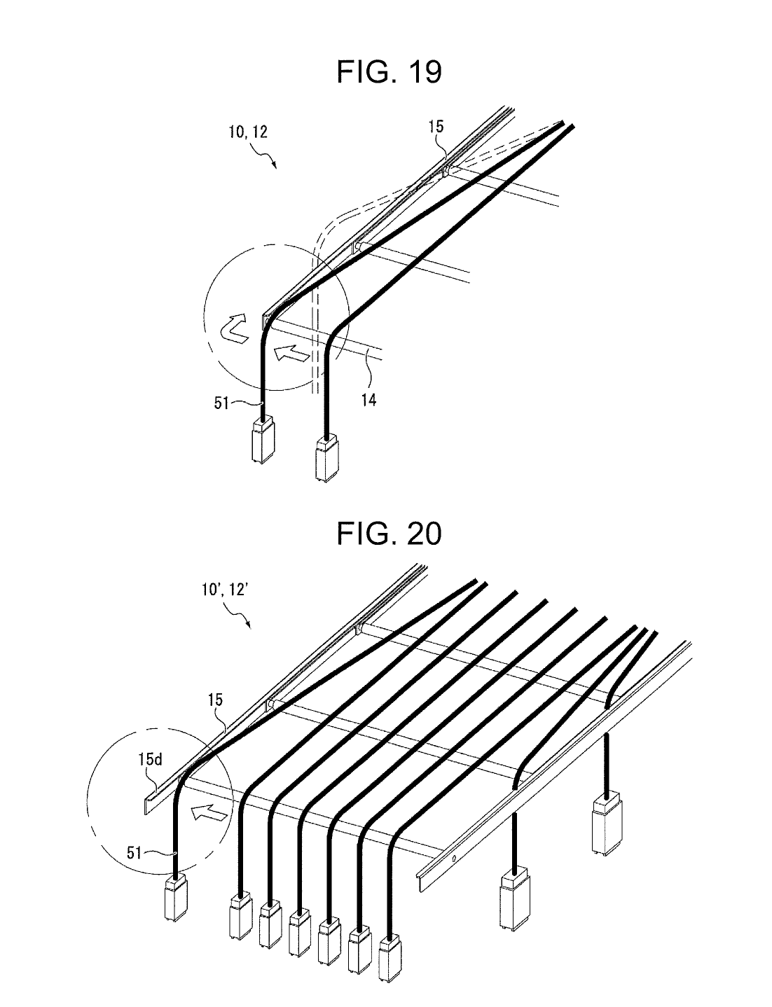

In short, the above-mentioned rack 10 (CMA 12) according to the fist embodiment is an apparatus where the lowest cable holding bar 14 is attached to the most front part of the support arms 15 for it. Therefore, with the rack 10, as depicted in FIG. 19, it follows that the cable 51 hanging on the lifted lowest cable holding bar 14 can move and fall from the lowest cable holding bar 14 during work.

The falling of the cables hinders work, however, the support arms 15′ for the lowest cable holding bar 14 of the rack 10′ (CMA 12′) according to the present embodiment has the cable guide part 15d. Consequently, with the rack 10′, as depicted in FIG. 20, even if a cable 51 hanging on the lowest cable holding bar 14 moves, the cable 51 does not fall.

### Fourth Embodiment

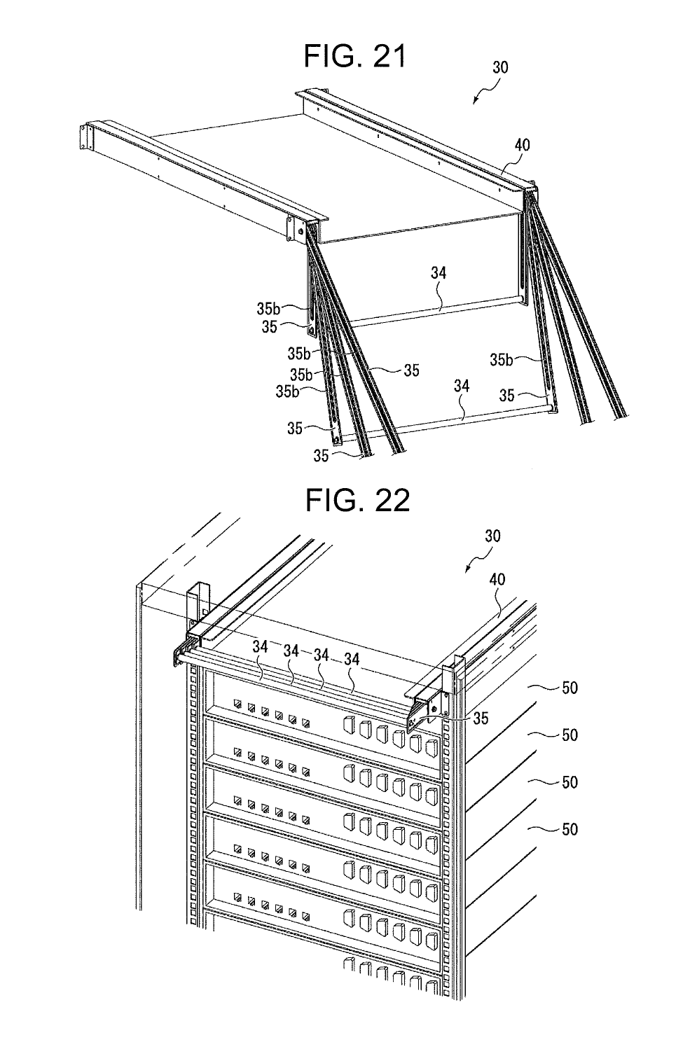

To begin with, a cable management device 30 according to a fourth embodiment of the present invention will be outlined referring to FIGS. 21 and 22. Incidentally, FIG. 21 is an outline view of the cable management device 30 (which will hereinafter also be termed the CM device 30) according to the fourth embodiment, and FIG. 22 is a diagram of the type of usage of the CM device 30.

As illustrated in FIGS. 21 and 22, the CM device 30 is a device capable of being housed in an ordinary rack in the same way as the electronic device 50. Further, the CM device 30 is a device which includes a housing part 40, N (N=4 in this embodiment) number of cable holding bars and N pairs of support arms 35, and which has such constitution that the N pairs of support arms 35 may be housed within the housing part 40.

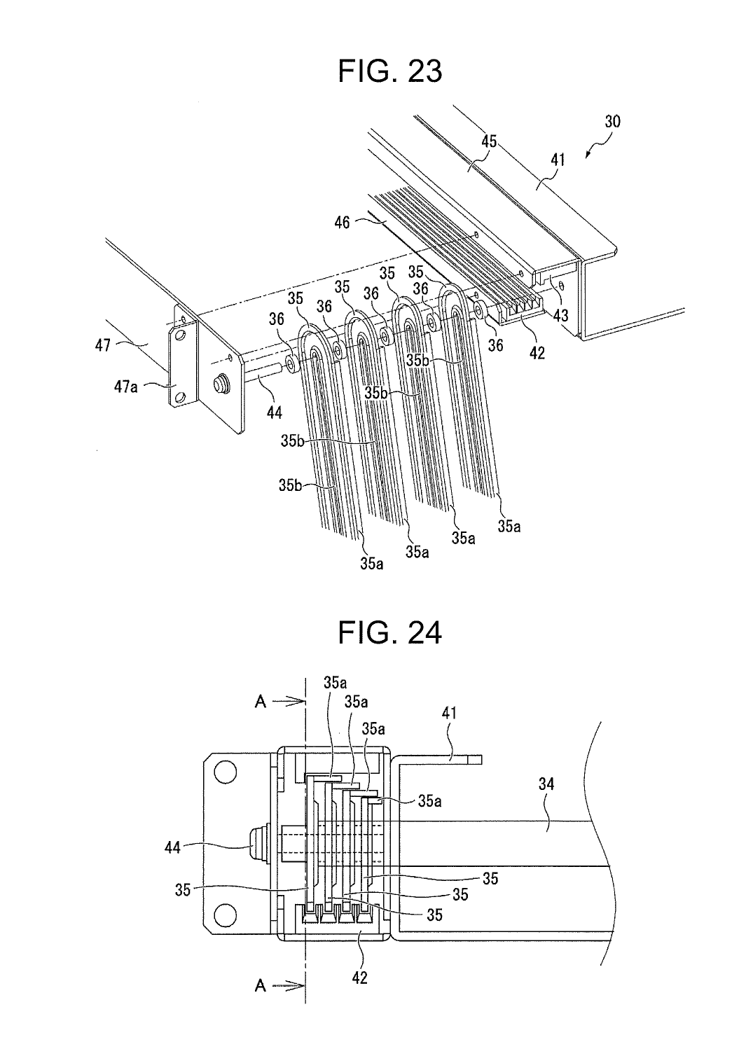

Hereinafter, the structure of the CM device 30 will be described more specifically referring also to FIGS. 23, 24, 25A and 25B. Note that the CM device 30 is a symmetrical device, and hence, in the following discussion, the description will be focused on the structure of the left side portion of the CM device 30 when viewed from the rear side.

The cable holding bar 34 (FIG. 21) is a rod-like member having a length slightly shorter than that of the cable holding bar 14 etc.

Each support arm 35 is a member having a front end part to which the cable holding bar 34 is rotatably attached. In FIGS. 21 and 22, each support arm 35 is depicted as a platelike member, however, an actual shape of each support arm 35 is the one that is illustrated in FIGS. 23 and 24.

That is, each support arm 35 is a member which includes an arm part which is a platelike member to which the cable holding bar 34 is attached, and a flange part 35a which is substantially perpendicular to the arm part and which has a cross section perpendicular to its longitudinal direction in an L-shape.

Moreover, the support arms 35 have such shapes that, when they are arranged on a plane with the flange parts 35a facing upward in order of their length (FIG. 24), the upper face of the flange part 35a of each support arms 35 comes into contact with the lower face of the flange part 35a of the next longer support arms 35. Further, a terminal end part of the arm part of each support arm 35 has a area where the flange part 35a does not exist. Furthermore, each support arm 35 has a groove (penetration hole) 35a that extends in the longitudinal direction of the support arm 35 and is apart from its side face with no flange part 35a (which will hereinafter be referred to as the first side face) by a predetermined distance.

The housing part 40 (FIG. 23) of the CM device 30 is a unit that includes, as the main components, a tray-shaped member 41, a first guide member 42 and a second guide member 43 attached to the right and left of the member 41, respectively, a rotary shaft 44, a side board 47, etc.

The rotary shaft 44 is a member that is inserted into the grooves 35a of the N number of support arms 35 and “N+1” number of spacers 36 (and the side board 47) and then is fixed to the member 41.

The first guide member 42 is a member having four parallel grooves each for slidably supporting the part on the first side face side of the support arm 35. This first guide member 42 is a member that is attached to the member 41, after being attached to the member 46 which forms an outer shell (a housing) of the CM device 30. Moreover, the detailed shape (mainly length) and the attachment position of the first guide member 42 are determined so that the distance D1 between the end part on the front side in FIG. 23 and the center of the rotary shaft 44 seen from above becomes longer than the distance D0 between the first side face of the support arm 35 and the center of the groove 35a.

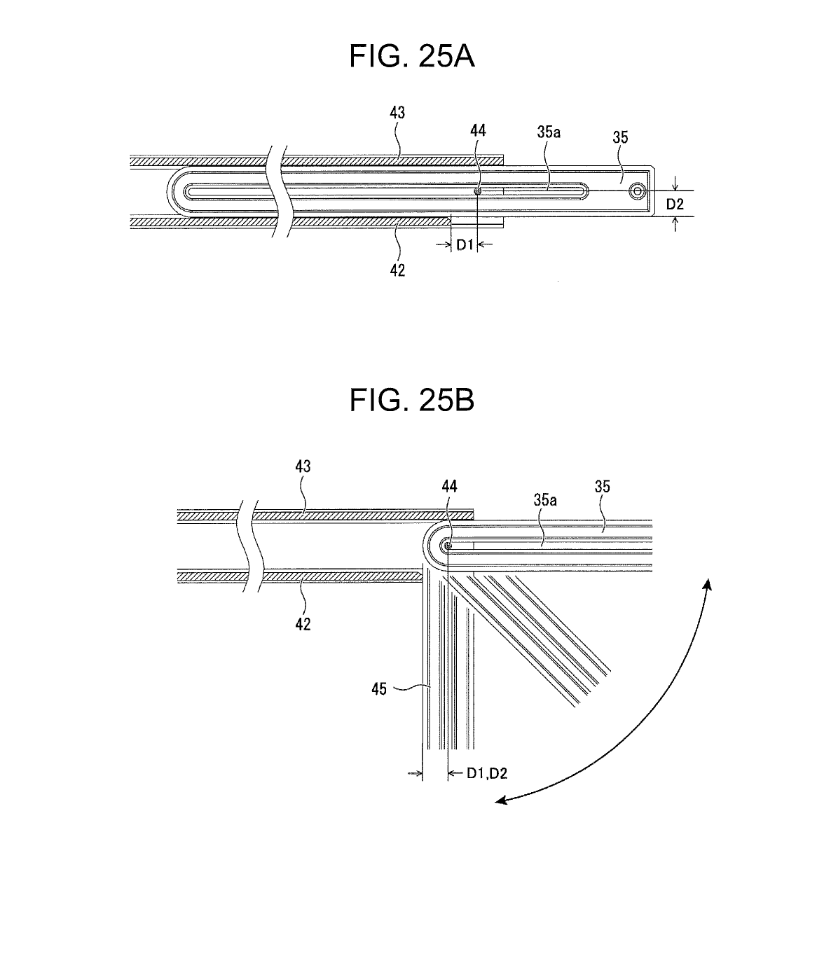

That is, as obvious from FIGS. 25A and 25B, in a case where the distance D1 is shorter than the distance D0, the support arm 35 can not rotate 90 degrees on the rotary shaft 44. The detailed shape and the attachment position of the first guide member 42 is therefore determined so that the distance D1 becomes longer than the distance D0. Note that FIGS. 25A and 25B are sectional views of the cable management device according to the fourth embodiment, which is viewed from the arrow direction of the A-A line in FIG. 24

The second guide member 43 is a member whose lower face comes in contact with the upper face of the flange part 35a of the longest support arm 35. This second guide member 43 is a member that is fixed to the member 41 after being attached to a member 45 for forming an outer shell of the CM device 30. Note that, the second guide part 43 used for the CM device 30 according to the preset embodiment is a member whose length in a front-back direction is equal to that of the member 41.

The side board 47 is a member that forms the outer shell of the CM device 30. To the side board 47, a rack fixing flange part 47a for fixing the CM device 30 to a rack. The attachment position of the rack fixing flange part 47a to the side board 47 is determined so that the distance D2 between the rear faces of the electronic devices 50 and the center of the rotary shaft 44 becomes longer than the distance D0 in order that a rotation of the support arm 35 may not be hindered by the rea faces of the electronic devices 50.

As discussed above, if all the cable holding bars 34 are pulled out from the CM device 30 and are lowered below, the CM device 30 functions as an apparatus wherein, when the n-th (n=1 to N) cable holding bar 14 is lifted, each of the “n+1”-th through the N-th support arms 15 is also lifted.

Consequently, if this CM device 30 is used, it is feasible to achieve an environment where the maintenance work for the electric device(s) connected with the cables from the ceiling side can be performed more easily.

Moreover, the CM device 30 has such constitution that when the lifted cable holding bar 34 is pushed in the depth direction, the cable holding bars 34 related to the lifted cable holding bar 34 enters the housing part 40. Consequently, with the CM device 30, just by lifting the n-th cable holding bar 24 and pushing it in the depth direction, a state where the n-th through N-th cable holding bars 24 does not fall down can be formed.

### Modified Examples

The technology related to the above mentioned embodiments can be modified in a variety of forms. For instance, the technology related to each embodiment may be modified such that only one end of each cable holding bar (14, 24 or 34) is supported by the support arm (15, 15′, 25 or 35). Note that, when the technology related to each embodiment is modified into such one, it is desirable to attach, for example, a circular board whose diameter is larger than the cable holding bar to the end of the cable holding bar which is not attached to the support arm in order to prevent the cable 51 from falling off.

Moreover, it is possible to add a mechanism corresponding to the projection parts 25c of the support arms 25 and the and one pair of arm holding members 27 that included in the CMA 22 according to the second embodiment (i.e. a function to prevent the support arms 25 from being easily loosened from the housing part 40) to the second embodiment at the CM device 30 according to the fourth embodiment.

All examples and conditional language provided herein are intended for the pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although one or more embodiments) of the present invention have been described in detail, it should be understood that the various changes, substitutions, and alterations could be made hereto without departing from the spirit and scope of the invention.

What is claimed is:

1. A rack, comprising:
a rack body part in which electronic devices are housed vertically; and
cable holding bars each of which is fixed to one of fixing members each pivotably supported by a rotary shaft provided on the rack body part so as to be vertically rotatable, each of the cable holding bars being extended in an axis direction of the rotary shaft;
wherein each of the fixing members has such a shape that distances between the cable holding bars and the rotary shaft mutually differ, and, when a cable holding bar is rotated upward, each fixing member to which the cable holding bar is fixed whose distance from the rotary shaft is larger than that of the lifted cable holding bar is rotated upward.

2. The rack according to claim 1, further comprising a state keeping mechanism to keep a state of a cable holding bar rotated upward as it is.

3. The rack according to claim 2, wherein the state keeping mechanism keeps the state of the cable holding bar rotated upward when the cable holding bar rotated upward is pushed into the rack body part.

4. The rack according to claim 2, wherein the state keeping mechanism has a latching function of permitting a status change of the cable holding bar rotated upward when an external force equal to or larger than a predetermined value is added.

5. The rack according to claim 1, wherein the fixing member for the cable holding bar whose distance from the rotary shaft is largest has a cable guide which is a front end part of the fixing member and of which length is equal to or larger than the diameter of a cable.

6. A cable management device for a rack in which electronic devices are housed vertically, the cable management device comprising:
a housing having a shape capable of being placed in the rack; and
a cable management assembly attached to the housing so as to be housed in the housing and to be taken out from the housing;
wherein the cable management assembly includes fixing members that are rotatable on a rotary shaft provided on the housing, cable holding bars each of which is fixed to one of fixing members and is extended in an axis direction of the rotary shaft,
wherein the fixing members cable holding bars have such shape and position relationship that distances between the cable holding bars and the rotary shaft mutually differ and, when a cable holding bar is lifted, each fixing member to which the cable holding bar is fixed whose distance from the rotary shaft is larger than that of the lifted cable holding bar to rotate upward.
